(19) United States
(12) Patent Application Publication
(10) Pub. No.: US 2016/0314780 A1
(43) Pub. Date: Oct. 27, 2016

(54) INCREASING USER INTERACTION PERFORMANCE WITH MULTI-VOICE TEXT-TO-SPEECH GENERATION

(71) Applicant: Microsoft Technology Licensing, LLC, Redmond, WA (US)

(72) Inventors: Anirudh Koul, Sunnyvale, CA (US); Meher Anand Kasam, San Francisco, CA (US); Yoeryoung Song, Mountain View, CA (US); Travis Alexander Gingerich, San Francisco, CA (US); Faisal Ilaiwi, Bellevue, WA (US); Ashish Sumant, Mountain View, CA (US)

(21) Appl. No.: 14/697,614

(22) Filed: Apr. 27, 2015

(51) Int. Cl. G10L 13/033; G06F 17/27; G10L 13/047

(52) U.S. Cl. CPC G10L 13/033; G10L 13/047; G06F 17/278

(57) ABSTRACT

Auxiliary content provided in addition to search results is selected and presented to aid the user in completing tasks and increasing user interaction performance. Auxiliary content is processed utilizing existing search engine categorization and identification mechanisms, thereby facilitating the determination of similarities between the auxiliary content and indexed content that is identified as being responsive to a search query. At least some of the search results identified as being responsive to the search query are compared to auxiliary content to identify similarities, including visual similarities. Similar auxiliary content are selected to aid the user in completing tasks, and such selected auxiliary content is provided with the search results, including in a visually distinct or separated manner.

### BACKGROUND

As the quantity of content that users consume through their computing devices increases, situations increasingly arise where the visual consumption of content from a computing device is impractical or undesirable. For example, users often spend significant portions of their workday driving a vehicle. Such periods of time could be used to consume content from a computing device, but such content would need to be consumed in a manner that would not distract the user from their task of driving the vehicle. As another example, users can desire to consume content from computing devices while exercising or performing other tasks that prevent them from visually consuming content. One mechanism of consuming content from a computing device that can be utilized in such situations is the consumption of content in an aural manner. More specifically, so-called “text-to-speech” functionality can be implemented by a computing device, which can cause the computing device to generate sound in the form of voiced words. In such a manner, a user can consume textual content from a computing device by listening to the computing device read aloud such textual content to the user and without having to visually engage with the computing device.

### SUMMARY

A computing device's reading aloud of textual content can quickly become monotonous, and, consequently, users can have a difficult time retaining focus, thereby negatively impacting the user's consumption of such content and decreasing the user's interaction performance with the computing device. To avoid such monotony, and enable a user to more easily maintain focus and consume content aurally, and thereby increase the user's interaction performance and engagement with the computing device, textual content can be read aloud by a computing device utilizing multiple voices. Person entities referenced by the textual content can be identified, and the words attributed to such person entities in the textual content, such as in the form of quotations, can be identified and associated with the corresponding person entities. A speaking script delineating the textual content in accordance with words spoken by identified person entities can be generated, with the remaining words of the textual content being attributed to a narrator differing from the identified person entities. Additionally, information regarding the identified person entities, which is relevant to the vocal characteristics of such person entities, can be obtained, both from information contained in the textual content itself, as well as from external knowledge bases. The vocal characteristic information can then be utilized to select from among existing computer voices having targeted voice characteristics corresponding thereto. Additionally, a different narrator voice can be selected. The textual content can then be read aloud by a computing device generating sounds in the form of voiced words utilizing the different selected computer voices for the different identified entities and the narrator, in accordance with the generated speaking script.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system providing for the reading aloud of textual content by a computing device utilizing multiple computer voices;

FIG. 2 is a diagram of an exemplary parsing of textual content to identify textual content to be read aloud by a computing device utilizing multiple computer voices;

FIG. 3 is a block diagram of exemplary components for reading aloud textual content by a computing device utilizing multiple computer voices;

FIG. 4 is a flow diagram of an exemplary reading aloud of textual content by a computing device utilizing multiple computer voices; and

FIG. 5 is a block diagram of an exemplary computing device.

### DETAILED DESCRIPTION

The following description relates to improving users' interaction performance by generating sound in the form of voiced words speaking textual content to the user utilizing multiple computer voices, thereby avoiding the monotony of presenting voiced textual content utilizing a single voice, and enabling users to better retain focus on the consumption of such content, and, in such a manner, improving users interaction performance. Person entities referenced by the textual content can be identified, and the words attributed to such person entities in the textual content, such as in the form of quotations, can be identified and associated with the corresponding person entities. A speaking script delineating the textual content in accordance with words spoken by identified person entities can be generated, with the remaining words of the textual content being attributed to a narrator differing from the identified person entities. Additionally, information regarding the identified person entities, which is relevant to the vocal characteristics of such person entities, can be obtained, both from information contained in the textual content itself, as well as from external knowledge bases. The vocal characteristic information can then be utilized to select from among existing computer voices having targeted voice characteristics corresponding thereto. Additionally, a different narrator voice can be selected. The textual content can then be read aloud by a computing device generating sounds in the form of voiced words utilizing the different selected computer voices for the different identified entities and the narrator, in accordance with the generated speaking script.

The techniques described herein make reference to the utilization of multiple computer voices in the reading aloud of textual content by a computing device. As utilized herein, the term “computer voice” means any collection of data that is utilizable by a computing device to generate sound, by the computing device, in the form of voiced words. Consequently, the term “computer voice” includes computer-generated voices, where each sound is derived from a mathematical representation, and human-based voices, where a computing device pieces together words, syllables, or sounds that were originally spoken by a human in digitized for manipulation by computing device. Additionally, references herein to a computing device “reading” or “reading aloud” textual content means that the computing device generates sound in the form of voiced words from the words of the textual content. Lastly, as utilized herein, the terms “text” and “textual content” mean computer-readable content that comprises words of one or more human-understandable languages, irrespective of the format of the data in which such computer readable content is stored, communicated or encapsulated. While the techniques described herein are directed to text-to-speech generation by computing devices, they are not meant to suggest a limitation of the described techniques to linguistic speech. To the contrary, the described techniques are equally utilizable with any communicational paradigm including, for example, sign language, invented languages, and the like.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

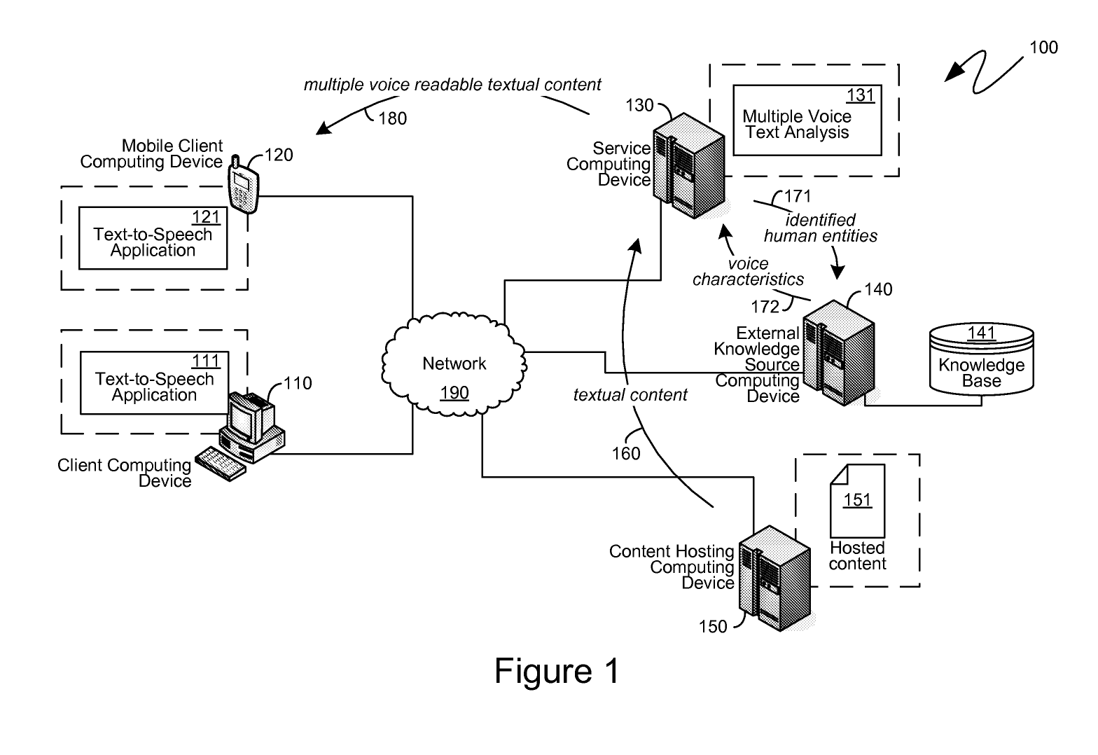

With reference to FIG. 1, an exemplary system 100 is illustrated, providing context for the descriptions below. The exemplary system 100 of FIG. 1 is shown as comprising a traditional desktop client computing device 110, and a mobile client computing device 120 that are both communicationally coupled to a network 190. The network 190 also has, communicationally coupled to it, an external knowledge source, represented by the computing device 140, a content hosting computing device, such as exemplary content hosting computing device 150, and a service computing device, such as exemplary service computing device 130, which can provide services to one or more of the mobile client computing device 120 and the desktop client computing device 110, such as the aforementioned multi-voice text-to-speech services. The illustration of the service computing device 130, the external knowledge source computing device 140 and the content hosting computing device 150 as single devices is strictly for illustrative simplicity, and the descriptions below are equally applicable to processes executing on a single computing device, executing across multiple computing devices, either in serial or in parallel, and/or executing on one or more virtual machine computing devices being executed on, and supported by, one or more physical computing devices.

As indicated previously, textual content can be consumed by users of client computing devices, such as the exemplary client computing device 110, or the exemplary mobile client computing device 120, by having those client computing devices generate sound in the form of voiced words that read aloud the textual content to the user. According to one aspect, to increase user interaction performance, the reading aloud of the textual content, by a client computing device, can be performed utilizing multiple computer voices, thereby avoiding monotony and enabling the user to focus more easily on the consumption of such content, and, in such a manner, increasing the user's interaction performance with the computing device. While the ultimate sounds, in the form of voiced words speaking the textual content, can be generated by the client computing device transmitting communicational signals to sound generating devices communicationally coupled thereto, such as speakers, headphones, or other like sound generating devices, the processing preceding such sound generation can be performed either locally on the client computing device, remotely in one or more server computing devices, or by combinations thereof.

For purposes of illustration, the exemplary system 100, shown in FIG. 1, comprises a service computing device, namely the exemplary service computing device 130, providing exemplary multiple voice text analysis functionality 131. In accordance with such illustration, therefore, the service computing device 130 can receive textual content, such as exemplary textual content 160, and can generate therefrom multiple voice readable textual content, such as exemplary multiple voice readable textual content 180, which can then be communicated to a client computing device, such as the client computing device 110 or the mobile client computing device 120, such as via the network 190. The receiving client computing device can then generate the sound, in the form of voiced words, in accordance with the instructions and information contained in the multiple voice readable textual content 180.

Alternatively, although not illustrated in the exemplary system 100 of FIG. 1, a client computing device, such as the exemplary client computing device 110 or the exemplary mobile client computing device 120, can itself comprise the multiple voice text analysis functionality, such as exemplary multiple voice text analysis functionality 131 that is illustrated in FIG. 1 as being provided by the service computing device 130. In such an alternative, the textual content 160 can be obtained directly by such a client computing device, such as via the network 190. In yet another alternative, the multiple voice text analysis functionality can be provided by multiple computing devices acting in concert such as, for example, a client computing device, such as the exemplary client computing device 110 or the exemplary mobile client computing device 120, acting in concert with a server computing device, such as exemplary service computing device 130. As such, while the descriptions below will be provided within the context of the exemplary system 100 shown in FIG. 1, those of skill in the art will recognize, in view of the expressly stated alternatives above, that the processing and mechanisms described can be modified so as to accommodate client-only processing or hybrid client-server processing.

Within the context of the exemplary system 100 of FIG. 1, textual content that is to be read aloud to a user by a client computing device can be provided to multiple voice text analysis functionality, such as exemplary multiple voice text analysis functionality 131 provided by the service computing device 130. According to one aspect, such textual content can be obtained from other computing devices, such as the exemplary content hosting computing device 150, which can host the hosted content 151. For example, the exemplary content hosting computing device 150 can be a news website, and the exemplary hosted content 151 can be a news article that a user wishes to have read to them. As another example, the exemplary content hosting computing device 150 can be a blog hosting website, and the exemplary hosted content 151 can be a blog entry that the user wishes to have read to them. In such an aspect, textual content 160, which can be a news article, blog post, or other like textual content, can be provided to the service computing device 130, such as via the network 190. For example, a user utilizing a web browsing application, or other like content consuming application, can identify the hosted content 151 to the service computing device 130, or otherwise indicate, such as via network communications across the network 190, that the textual content 160 is to be obtained by the service computing device 130 from the content hosting computing device 150.

Upon receipt of the textual content 160, the multiple voice text analysis functionality 131 can parse the textual content 160 and identify human entities referenced within such content. Additionally, as will be detailed further below, the multiple voice text analysis functionality 131 can associate quotes, or words indicated, by the textual content 160, to have been spoken by such human entities, with the identified human entities. The multiple voice text analysis functionality 131 can then select differing computer voices to be utilized to voice such words. In selecting such differing computer voices, the multiple voice text analysis functionality 131 can identify voice characteristics, such as age, gender, nationality, and other like characteristics that can be indicative of the tonal qualities of a human's voice. Consequently, as utilized herein, the term “voice characteristics” means those characteristics that are indicative of the tonal qualities of a human's voice.

To identify voice characteristics of the human entities identified within the textual content 160, the multiple voice text analysis functionality 131 can obtain information from the textual content 160 itself. Additionally, according to one aspect, the multiple voice text analysis functionality 131 can reference external knowledge sources, such as a knowledge base 141, hosted by an external knowledge source computing device, such as the exemplary external knowledge source computing device 140. As utilized herein, the term “external knowledge source” or “external knowledge base” means a collection of information, external to the textual content that will be read aloud to a user, that independently provides encyclopedic or reference information. Examples of such external knowledge sources include web-based encyclopedias, user-maintained encyclopedic databases, encyclopedias accessible through application program interfaces (APIs) or external mapping files and other like encyclopedic or reference sources. Thus, while illustrated in the exemplary system 100 of FIG. 1 as a separate computing device, the external knowledge source can be a separate process executing on, for example, the service computing device 130, or any other computing device, that can be accessed through an API call or other like invocation.

Consequently, as illustrated by the exemplary communications 171 and 172, the multiple voice text analysis functionality 131 can search the knowledge base 141 for the identified human entities 171 and, in return, can receive voice characteristics 172, for those identified human entities 171, including, for example, the age of those identified human entities 171, their gender, their nationality, and other like voice characteristics. Utilizing such information, the multiple voice text analysis functionality 131 can computer voices that match the voice characteristics of the identified human entities. The multiple voice text analysis functionality 131 can then generate a multiple voice readable textual content, such as exemplary multiple voice readable textual content 180, which can be provided to a client computing device that can utilize such multiple voice readable textual content 180 to read aloud to the textual content 162 a user utilizing multiple different computer voices.

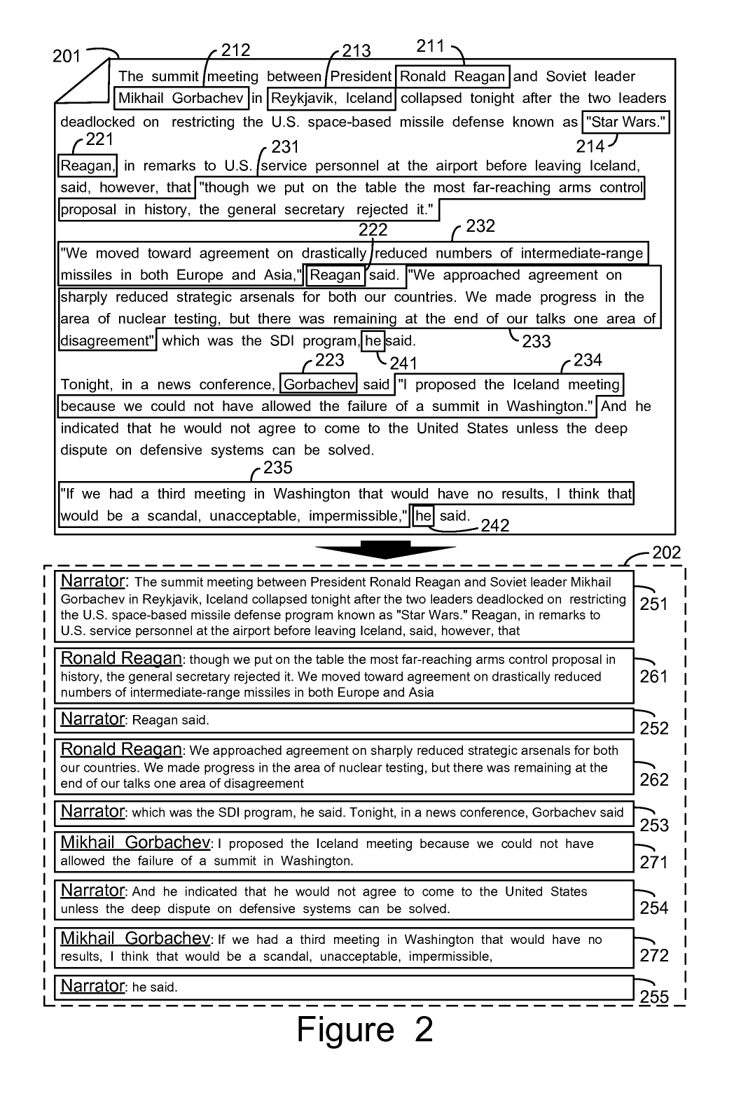

Turning to FIG. 2, the mechanisms described herein are illustrated within the context of the exemplary textual content 201. For purposes of illustration, the exemplary textual content 201 comprises an exemplary news article. In analyzing the exemplary textual content 201, identification can be made of various entities identified therein, such as, for example, the “Ronald Reagan” entity 211, the “Mikhail Gorbachev” entity 212, the “Reykjavik, Iceland” entity 213 and the “Star Wars” entity 214. Subsequently, those entities that are not human entities, such as, for example, geographic entities, landmark entities, titular entities, and the like, can be filtered out. For example, “Reykjavik, Iceland” entity 213 can be identified as a location, or geographic entity. Similarly, the “Star Wars” entity 214 can be identified as a title. Consequently, the “Ronald Reagan” entity 211 and the “Mikhail Gorbachev” entity 212 can be the human entities that are identified within the textual content 201.

According to one aspect, further processing can associate short form names of entities with their longer form. For example, the “Reagan” entities 221 and 222 and the “Gorbachev” entity 223 can, initially, be identified as separate entities from the “Ronald Reagan” entity 211 and the “Mikhail Gorbachev” entity 212. Subsequent processing can identify the “Reagan” entities 221 and 222 as being shortened forms of the “Ronald Reagan” entity 211. Likewise, the “Gorbachev” entity 223 can be identified as a short form of the “Mikhail Gorbachev” entity 212. Such an association can aid in the subsequent identification of quotations, or words within the textual content 201 that the textual content 201 attributes as being spoken by one or more of the human entities, and can aid in the association of such identified quotations to the human entities that are to have spoken those words.

Co-reference resolution can also be utilized to associate pronouns, such as the “he” pronouns 241 and 242 with corresponding identified human entities. As will be recognized by those skilled in the art, co-reference resolution can be utilized to determine that the “he” pronoun 241 refers to the “Ronald Reagan” entity 211 because it appears after reference to the “Ronald Reagan” entity 211, namely in the form of the short form “Reagan” entity 222. Analogously, co-reference resolution can be utilized to determine that the “he” pronoun 242, on the other hand, refers to the “Ronald Reagan” entity 211 because it appears after reference to the “Mikhail Gorbachev” entity 212, namely in the form of the short form “Gorbachev” entity 223.

As indicated previously, the textual content 201 can comprise quotations, or collections of words that the textual content 201 attributes as being spoken by one or more of the human entities identified therein. Processing of the textual content 201 can identify quotations through various means including, for example, by reference to quotation marks, indentations or paragraph spacing, and other like indicators of quotations. For example, within the exemplary textual content 201, quotations 231, 232, 233, 234 and 235 can be identified. Subsequently, such quotations can be associated with specific ones of the identified human entities that the textual content 201 indicates to have spoken such words. As will be recognized by those skilled in the art, such an association can be identified through the textual indicators within the textual content 201, such as the word “said” and synonyms thereof, the presence of punctuation, such as a colon, and other like textual indicators. For example, the quotation 231 can be associated with the “Ronald Reagan” entity 211 due to the presence of the short form “Reagan” entity 221 followed by the word “said”. In a similar manner, the quotations 232 and 233 can, likewise, also be associated with the “Ronald Reagan” entity 211. As another example, the quotation 234 can be associated with the “Mikhail Gorbachev” entity 212 due to the presence of the short form “Gorbachev” entity 223, again followed by the word “said”. In a similar manner, the quotation 235 can also be associated with the “Mikhail Gorbachev” entity 212 due to its being followed by the pronoun “he” 242 and the word “said” and due to the pronoun “he” 242 being associated with the “Mikhail Gorbachev” entity 212 by the co-reference resolution described above.

According to one aspect, a multiple voice readable textual content, such as the exemplary multiple voice readable textual content 202, can be generated from the exemplary textual content 201. As illustrated in FIG. 2, the exemplary multiple voice readable textual content 202 can divide the words of the textual content 201 into groupings or portions that are to be voiced using a specific computer voice when being read aloud by a computing device. Colloquially, a multiple voice readable textual content can be conceptualized as a form of a script, such as would typically be used in a stage production, such as a play, where words are associated with the person who is to speak them. The words of the exemplary textual content 201 that were identified, within the exemplary textual content 201, as having been spoken by a specific identified human entity, can be associated with that human entity in the exemplary multiple voice readable textual content 202. Thus, for example, the quotations 231 and 232, which were attributed to the “Ronald Reagan” entity 211, can be associated with the “Ronald Reagan” entity 211 in the portion, or component, 261. Analogously, the quotation 233, which was also attributed to the “Ronald Reagan” entity 211, can be associated with the “Ronald Reagan” entity 211 in the portion 262. In a similar manner, the quotations 234 and 235, which were attributed to the “Mikhail Gorbachev” entity 212, can be associated with the “Mikhail Gorbachev” entity 212 in the portions 271 and 272, respectively.

The remaining portions of the textual content, such as the words that are not expressly indicated as having been spoken by one of the identified human entities, can be associated with a “narrator”, or other like generic human entity, for purposes of utilizing a different computer voice. Thus, as illustrated by the exemplary multiple voice readable textual content 202, portions 251, 252, 253, 254 and 255 can identify those words, from the exemplary textual content 201, that are to be spoken by the narrator entity, and can associate such words with the narrator entity.

Although not specifically illustrated in FIG. 2, the exemplary multiple voice readable textual content 202 can further comprise an identification of the computer voices that are to be utilized for each of the human entities identified therein, or for each of the components, such as the exemplary components referenced above and illustrated in FIG. 2. In such a manner, a multiple voice readable textual content can comprise the words that are to be read aloud by a computing device, as well as the manner in which the computing devices to read those words, namely the computer voice of the computing devices to utilize in generating the sound that is in the form of the voiced words speaking such textual content.

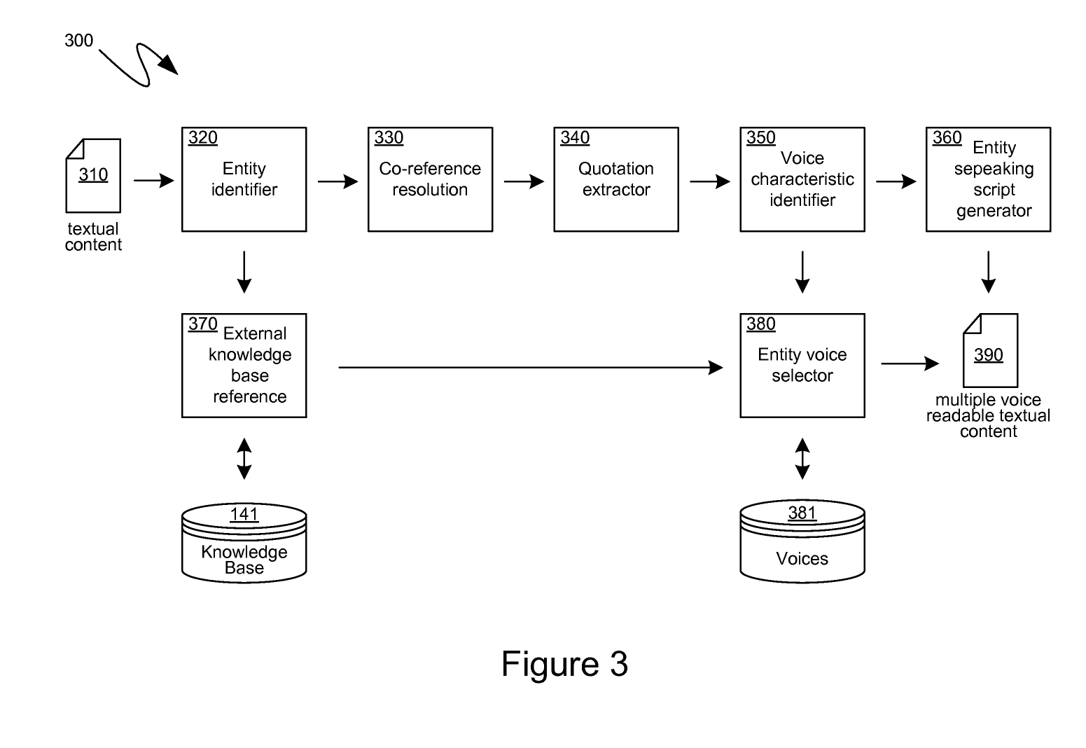

Turning to FIG. 3, the exemplary system 300 shown therein illustrates an exemplary series of components that can be utilized to create multiple voice readable textual content, such as exemplary multiple voice readable textual content 390, from input textual content, such as exemplary textual content 310. Initially, an entity identifier, such as the exemplary entity identifier 320 can identify named entities within the textual content 320. As described above, such entity identification can include matching short form entity names to longer form entity names, as well as identifying human entities as opposed to other types of entities. Subsequently, a co-reference resolution component, such as the exemplary co-reference resolution component 330 can correlate pronouns in the textual content 310 to one or more of the entities that were identified by the entity identifier 320.

According to one aspect, and as indicated previously, the textual content 310 can be analyzed by a voice characteristic identifier, such as the exemplary voice characteristic identifier 350, to identify voice characteristics of one or more of the entities identified by the entity identifier 320. For example, as indicated previously, the age of the human entity can be a voice characteristic since, as will be recognized by those skilled in the art, a human's voice changes as they age. Thus, if the textual content 310 is, for example, a news article, then such forms of textual content often contain the ages of human entities identified by such news articles. Consequently, in such an example, the voice characteristic identifier 350 can associate the age specified in the textual content 310 of one of the entities identified by the entity identifier 320, and can associate such an age with that entity. As another example, and as also indicated previously, the gender of a human entity can be a voice characteristic since, as will also be recognized by those skilled in the art, female voices typically sound different than male voices. The gender of human entities can often be identified based on the pronouns utilized to reference such human entities. Consequently, the voice characteristic identifier 350 can, for example, utilize the association between pronouns and specific human entities that can have been generated by the co-reference resolution component 330, and can, thereby, determine whether the human entities identified by the entity identifier 320 are male or female, and can associate such gender information with such human entities. Other voice characteristics, such as, for example, nationality, can likewise, be identified by the voice characteristic identifier 350. For example, the voice characteristic identifier 350 can reference a mapping between names and genders or nationalities. Such a mapping could indicate, for example, that there is a high percentage chance that a human entity with the name “Mikhail” is a male or is of a Slavic nationality.

A quotation extractor, such as the exemplary quotation extractor 340 can, as indicated previously, identify quotations, or other words indicated by the textual content 310 to have been spoken by, or otherwise attributed to, one or more of the human entities identified by the entity identifier 320. The quotation extractor 340 can then associate the extracted quotations with the human entities, identified by the entity identifier 320, that the textual content 310 indicates to have spoken the quotations. From such information, an entity speaking script can be generated by the entity speaking script generator 360. As illustrated in FIG. 2, and as described in detail above, such an entity speaking script can be analogous to a script utilized in stage productions, where spoken words are associated with a specific human entity that is to speak those words. According to one aspect, the entity speaking script generator 360 can associate the words of the quotations, identified by the quotation extractor 340, with the human entities, identified by the entity identifier 320, that the textual content 310 indicates to have spoken them. Words from the textual content 310 that are not associated with a specific human entity can be associated with a narrator entity. Such an entity can be created by the entity speaking script generator 360 for purposes of generating an entity speaking script.

The entity speaking script generated by the entity script generator 360 can be combined with information identifying which computer voices are to be utilized by a computing device to generate sound, in the form of voiced words speaking aloud the textual content 310. Such a combination can be the aforementioned multiple voice readable textual content, which, in the exemplary system 300 of FIG. 3, is illustrated as the multiple voice readable textual content 390. According to one aspect, the identification and selection of which computer voices are to be utilized for each of the entities in the multiple voice readable textual content 390 can be performed by an entity voice selector, such as the exemplary entity voice selector 380.

More specifically, the entity voice selector 380 can select from among computer voices, such as computer voices available in a computer voice database, such as the exemplary computer voice database 381, that match the voice characteristics associated with the human entities identified by the entity identifier 320. As detailed above, such voice characteristics can have been identified, by the voice characteristic identifier 350, from information contained in the textual content 310. The textual content 310 may, however, not contain sufficient information for the voice characteristic identifier 350 to identify one or more voice characteristics for each of the human entities, identified by the entity identifier 320, that are associated with spoken words by the entity speaking script generator 360.

According to one aspect, therefore, the human entities identified by the entity identifier 320, or, at least those of the human entities that are associated with spoken words, by the entity speaking script generator 360, can be provided to an external knowledge base reference component 370, which can then reference external knowledge bases, such as the exemplary external knowledge base 141, to obtain additional voice characteristics for those human entities. For example, and with reference to the exemplary textual content 201, shown in FIG. 2, and described in detail above, that exemplary textual content 201 contains little information regarding the age, gender, nationality, or other voice characteristic of either of the human entities identified therein, namely the exemplary “Ronald Reagan” entity 211 and “Mikhail Gorbachev” entity 212. More specifically, the “he” pronouns 241 and 242, in the exemplary textual content 201, can indicate that the gender of both the “Ronald Reagan” entity 211 and “Mikhail Gorbachev” entity 212, from the exemplary textual content 201, are male. Such information can have been obtained, such as from the exemplary textual content 201, by the voice characteristic identifier 350. Thus, if the exemplary textual content 201 had been provided to the system 300, the entity voice selector 380 can have received voice characteristic information, from the voice characteristic identifier 350, that was limited to identifying the “Ronald Reagan” entity 211 and “Mikhail Gorbachev” entity 212, from the exemplary textual content 201, as being male. As will be recognized by those skilled in the art, such information, by itself, may be insufficient to accurately select computer voices, such as from the computer voice database 381, for the “Ronald Reagan” entity 211 and “Mikhail Gorbachev” entity 212.

An external knowledge base reference component 370, however, can reference one or more external knowledge bases, such as the exemplary external knowledge base 141, to obtain additional voice characteristic information for human entities identified in the textual content being processed, such as, for example, the “Ronald Reagan” entity 211 and “Mikhail Gorbachev” entity 212 from the exemplary textual content 201, shown in FIG. 2. As indicated previously, an external knowledge base, such as the exemplary external knowledge base 141, is a collection of information, external to the textual content 310, that independently provides encyclopedic or reference information. Thus, in the present example, if the exemplary textual content 201, shown in FIG. 2, is being operated on by the system 300, then an external knowledge base reference component, such as the exemplary external knowledge base reference component 370, can reference external knowledge bases to search for “Ronald Reagan” and “Mikhail Gorbachev”. More specifically, because the “Ronald Reagan” entity 211 and “Mikhail Gorbachev” entity 212 reference non-fictional human entities, external knowledge bases, such as the exemplary external knowledge base 141, can comprise additional information regarding “Ronald Reagan” and “Mikhail Gorbachev”, including voice characteristic information, such as, for example, their ages, their nationalities, and other like voice characteristic information. For example, an encyclopedic knowledge base can identify a birth day month and year for the “Ronald Reagan” entity 211, thereby enabling a determination of his age, including his age at the time of the authoring of the exemplary textual content 201. An encyclopedic knowledge base can, likewise, identify a nationality, geographic region, or ethnic group to which the “Ronald Reagan” entity 211 belongs. In a similar manner, encyclopedic knowledge bases can comprise analogous information for the “Mikhail Gorbachev” entity 212.

Such information, including voice characteristic information, can be obtained, such as by the external knowledge base reference component 370, by searching the external knowledge bases, such as the exemplary external knowledge base 141, for appropriate keywords, such as, for example, “Ronald Reagan”. According to one aspect, if such searches result in multiple responsive search results, disambiguation as between those multiple responsive search results can be performed with reference to contextual information that can be obtained from the textual content being operated on. For example, if searching the knowledge base 141 for “Ronald Reagan” returns two different individuals with the same name, disambiguation as between those two individuals can be performed utilizing contextual information obtained from the textual content, such as, in the present example, exemplary textual content 201 of FIG. 2, including, for example, the fact that the “Ronald Reagan” referenced in the exemplary textual content 201 had met with a “Mikhail Gorbachev” in “Reykjavik, Iceland”.

More generally, external knowledge bases, such as the exemplary external knowledge base 141, can comprise additional information, including voice characteristic information, regarding human entities referenced in the textual content 310, so long as those human entities are not unique to the textual content 310. As such, external knowledge bases can comprise information relevance to the vocal characteristics of identified human entities, not only for nonfictional human entities of historical significance, but also for other nonfictional and fictional human entities, including popular fictional characters. For example, external knowledge bases can comprise information about fictional characters from, for example, a popular book series or a popular movie, play or other like dramatic work. As indicated previously, such information can include voice characteristic information such as, for example, the nationality of such characters, regions of the world in which such characters are said to have lived, the age of such fictional characters and other like information that can be utilized to identify computer voices that would more closely match the voices of such characters, were such characters actual, physically existing human beings.

Voice characteristic information obtained by the external knowledge base reference component 370 can also be provided to the entity voice selector 380 to facilitate a selection of one or more computer voices for each of the identified human entities having spoken words associated with them in the entity speaking script generated by the entity speaking script generator 360. More specifically, computer voices can be designed with specific vocal characteristics. For example, computer voices can be programmed, defined, designed, or otherwise created on a computing device to have lighter or darker timbre, frequency ranges that are higher or lower, more tightly defined, or more spread out, and various other audible characteristics. Such audible characteristics are typically quantified and conceptualized within the context of specific vocal characteristics. Thus, as a simple example, a computer voice that utilizes a greater proportion of low-frequency sounds can be quantified and conceptualized as a male voice, while one that generates a utilizes a greater proportion of higher frequency sounds can be quantified and conceptualized as a female voice. Such a vocal characteristics can be specified and can be associated with the data that defines the computer voice. Thus, a computer voice database, such as the exemplary computer voice database 381, can comprise data that defines a computer voice together with metadata in the form of associated vocal characteristics. For example, the exemplary computer voice database 381 can comprise data that defines one computer voice that is meant to sound like a middle-aged male that speaks English with a Scottish accent. As another example, the exemplary computer voice database can comprise data that defines another computer voice that is meant to sound like a older female that speaks English with a Slavic accent. Such vocal characteristics, including age, gender, nationality or accent, and other like local characteristics, can then be specified with the data defining the computer voice such that, in the first example, the data defining the computer voice can be associated with vocal characteristics conceptualizing the voice as that of a middle-aged male that speaks English with a Scottish accent.

In selecting voices for the human entities having spoken words associated with them in an entity speaking script, such as the entity speaking script that would be generated by the entity speaking script generator 360, the entity voice selector 380 can match the voice characteristics of available computer voices, such as those contained within the exemplary computer voice database 381, to the voice characteristics of the aforementioned human entities, such as the voice characteristics that were identified by the voice characteristic identifier 350 and by the external knowledge base reference component 370. For example, if the external knowledge base reference component 370 identifies the aforementioned “Mikhail Gorbachev” entity 212 as being an older male speaking English with a Russian accent, then the entity voice selector 380 an attempt to select a computer voice whose vocal characteristics are also those of an older male speaking English with a Russian, or some sort of Slavic, accent.

If none of the computer voices, in the exemplary computer voice database 381, exactly matches the vocal characteristics of a human entity associated with spoken words from the textual content 310, then, the entity voice selector 380 can prioritize specific ones of the vocal characteristics to select a corresponding computer voice. For example, priority can be given to gender, as a vocal characteristic, such that a male voice will be selected for an entity his vocal characteristics indicate that they are male, even if the selection of a male voice negatively impacts other vocal characteristics, such as age or nationality. As another example, vocal characteristics can be ranked, with, for example, age having a higher ranking then nationality, and gender having a higher ranking than age.

Once the entity voice selector 380 selects computer voices, such as from the exemplary computer voice database 381, for each of the human entities having spoken words associated with them in the entity speaking script, such as the entity speaking script that was generated by the entity speaking script generator 360, the identification of those selected computer voices, and their association with the identified human entities, together with the entity speaking script, can result in the multiple voice readable textual content 390. A multiple voice readable textual content, such as the exemplary multiple voice readable textual content 390, can then be provided, either to the same computing device implementing the exemplary system 300 of FIG. 3, or to a different computing device, such as a remote client computing device that requested that the textual content 310 be processed into the multiple voice readable textual content 390 to facilitate such a remote client computing device reading aloud the textual content 310, to a user, utilizing multiple computer voices.

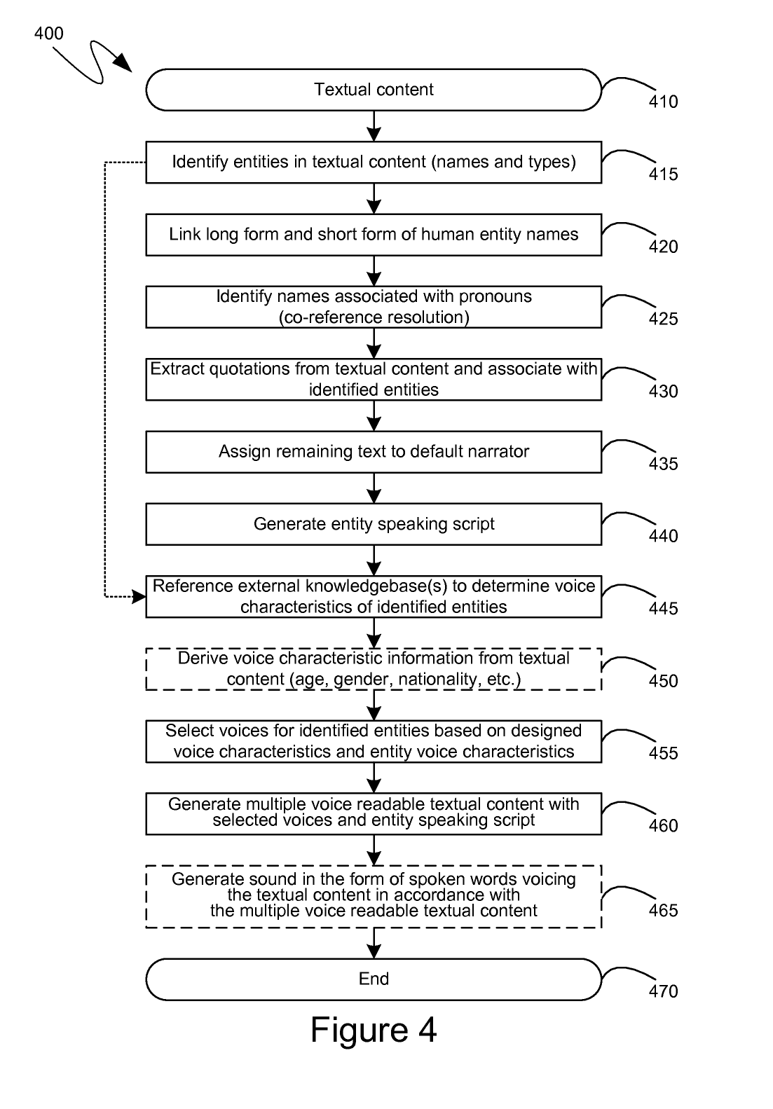

Turning to FIG. 4, the exemplary flow diagram 400 shown therein illustrates an exemplary series of steps by which textual content can be processed into multiple voice readable textual content, and, ultimately, read aloud to a user by a computing device utilizing multiple computer voices. Initially, as indicated by step 410, textual content can be received, either directly, or indirectly through the provision of a link or pointer to the textual content. Subsequently, at step 415, entities in the textual content can be identified. As described in detail above, the identification of such entities can include the determination of entity names, as well as types of entities. For example, and is also described in detail above, a determination of the type of an entity such as, for example, whether an entity is a human entity or a geographic location entity, can be based on linguistic cues and other contextual information obtained from the textual content 410. At step 420, the entities identified at step 415 can be compared to determine whether some of the entities that were identified at step 415 our merely differences in the nomenclature utilized to reference a single entity. More specifically, and as detailed above, at step 420, determinations can be made whether one entity is merely a short form name of another entity. Thus, for example, in the example referenced above, and illustrated in FIG. 2, the “Reagan” entity 221 and 222 can be identified is merely being a short form name of the “Ronald Reagan” entity 211. At step 420 such long form and short form names can be linked to signify a single entity nominated in different ways within the textual content, received at step 410.

The textual content, received at step 410, can reference entities through pronouns such as “he” or “she”. Consequently, at step 425, co-reference resolution, such as that described in detail above, can be utilized to associate specific entity names with specific pronoun instances within the textual content. Such co-reference resolution can facilitate the subsequent extraction of quotations from the textual content, at a subsequent step 430. More specifically, at step 430, as described in detail above, an identification can be made of the quotations and other words, phrases or statements within the textual content, received at step 410, that are attributed, by such textual content, as having been spoken by one or more of the entities identified at step 415. Such quoted words can, at step 430, be associated with the entity that the textual content indicates spoke such words. Because step 430 can occur subsequent to the identification of the entities at step 415, the linking of the long form and short form nomenclature of such entities, at step 420, and the co-reference resolution, at step 425, the processing of step 430 can accurately associate quoted words with specific entities.

The remaining text, of the textual content that was received at step 410, that is not indicated, by such textual content, as having been spoken by one of the identified entities, and which was not associated with one of the identified entities at step 430, can, at step 435, be associated with a default narrator. Subsequently, at step 440, an entity speaking script can be generated. As described in detail above, such an entity speaking script can divide the textual content, received at step 410, into words to be spoken by one or more entities, including the default narrator, to whom all of the remaining text was assigned at step 435. Colloquially, an entity speaking script, such as that generated at step 440, can be conceptualized as a play or movie script where words are associated with entities that are to speak such words.

At step 445, external knowledge bases can be referenced to determine voice characteristics of the entities in the entity speaking script that was generated at 440. While step 445 is illustrated as occurring subsequent to step 440, in one embodiment step 445 can be performed in parallel with one or more of the steps 420 through 440. Consequently, the exemplary flow diagram 400, shown in FIG. 4, illustrates that processing can proceed, such as from step 415, directly to step 445, which, as indicated, can be executed in parallel with one or more of the steps 420 through 440. As described in detail above, the reference to external knowledge bases, performed at step 445, can entail the searching of such external knowledge bases utilizing keywords identifying one or more of the entities in the entity speaking script that was generated at step 440. As also described in detail above, to the extent that such searching of external knowledge bases returns multiple results, the specific entity referenced by the textual content, received at step 410, can be disambiguated utilizing contextual information contained within the textual content. The voice characteristic information obtained by referencing external knowledge bases, at step 445, can, as defined above, be information that is indicative of the sound of a person's voice and can include a person's age, gender, nationality, dialect, accent, and any other like voice characteristic information.

As an optional step, indicated for such a reason via dashed lines in FIG. 4, voice characteristic information for one or more of the entities from the entity speaking script, generated 440, can also be derived from contextual content, and other like information obtained from the textual content, that was received at step 410. For example, and as detailed above, use of specific pronouns can indicate gender, which, as indicated, can be a form of voice characteristic information. Step 450 can identify such information, from the textual content received at step 410, and such derived voice characteristic information can be utilized to either supplement, or verify the voice characteristic information obtained from external knowledge bases at step 445.

Processing can then proceed to step 455, where computer voices can be selected for each of the entities in the entity speaking script, generated at step 440, in accordance with the voice characteristics of available computer voices as compared with the voice characteristics of the entities in the entity speaking script, as identified at step 440, and, optionally, step 445. As described in detail above, one mechanism by which computer voices can be selected, at step 445, can be based on a matching between the voice characteristics of a computer voice and the voice characteristics of an entity from the entity speaking script that was generated at step 440. As also described in detail above, another mechanism by which computer voices can be selected, at step 445, can apply a weighting or ranking to various voice characteristics, such as age, gender, accent, and the like. The computer voices, selected at step 445, can, then, based on a correlation between the voice characteristics of a computer voice and the voice characteristics of an entity in the entity speaking script for at least those voice characteristics that are higher weighted, or ranked.

The selected computer voices can be associated with the entities from the entity speaking script, which was generated at step 440, and the resulting collection of information, including the entity speaking script and the identification of the computer voices to be utilized for each of the entities identified therein, can be generated at step 460. Such multiple voice readable textual content can then the retained locally to instruct a computing device as to how to generate sound in the form of spoken words, thereby enabling the computing device to read aloud the textual content, received at step 410, with multiple computer voices. Alternatively, such a multiple voice readable textual content, generated at step 460, can be transmitted, such as through network communications, to a remote computing device, differing from the computing device executing the previously described steps, thereby enabling that computing device to read aloud the textual content, received at step 410, with multiple computer voices. The former is illustrated by the optional step 465 in the exemplary flow diagram 400 of FIG. 4. As before, step 465 is illustrated with dashed lines to indicate that it is optional, since step 465 would be performed by a different computing device if the multiple voice readable textual content, generated at step 460, was transmitted to such a computing device.

Insofar as the actual generation of sound, by a computing device, in the form of voiced words speaking the textual content utilizing multiple different computer voices, such sound generation can be performed by existing text-to-speech mechanisms, such as, for example, the exemplary text-to-speech applications 111 and 121, shown in FIG. 1. Such text-to-speech functionality can be provided individual portions of the multiple voice readable textual content on a per voice basis. For example, and with reference to FIG. 2, the portion 251 can be provided to an existing text-to-speech mechanism, with a further instruction, or automated selection, of a computer voice corresponding to the narrator. Subsequently, the portion 261 can be provided to the existing text-to-speech mechanism, with a further instruction, or automated selection, of a computer voice that was selected to correspond to the “Ronald Reagan” entity 211. In such a manner text can be read aloud to a user utilizing different computer voices while leveraging existing text-to-speech functionality. Alternatively, customized mechanisms can be created that leverage known text-to-speech functionality, but further comprise the ability to understand the specification of different computer voices for different textual portions of a single multiple voice readable textual content.

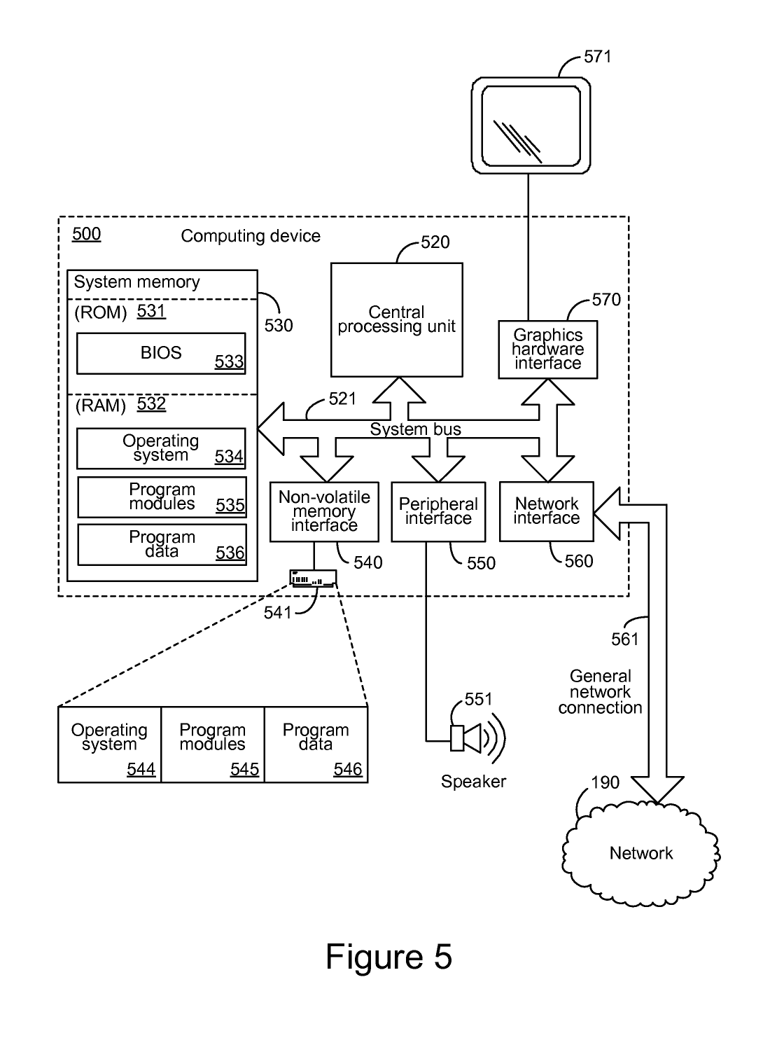

Turning to FIG. 5, an exemplary computing device 500 is illustrated which can perform some or all of the mechanisms and actions described above. The exemplary computing device 500 can include, but is not limited to, one or more central processing units (CPUs) 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, including, but not limited to, a graphics hardware interface 570 and a display device 571, which can include display devices capable of receiving touch-based user input, such as a touch-sensitive, or multi-touch capable, display device. The computing device can further comprise peripherals for presenting information to a user in an aural manner, including, for example, sound-generating devices such as speakers. The exemplary computing device 500 is shown in FIG. 5 as comprising a peripheral interface 550, communicationally coupled to the system bus 521, with peripherals such as the speaker 551 communicationally coupled thereto. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, other program modules 535, and program data 536.

The computing device 500 may also include other removable/non-removable, volatile/nonvolatile computer storage media. By way of example only, FIG. 5 illustrates a hard disk drive 541 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 541 is typically connected to the system bus 521 through a non-volatile memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 may operate in a networked environment using logical connections to one or more remote computers. The computing device 500 is illustrated as being connected to the general network connection 561 through a network interface or adapter 560, which is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

Although described as a single physical device, the exemplary computing device 500 can be a virtual computing device, in which case the functionality of the above-described physical components, such as the CPU 520, the system memory 530, the network interface 560, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 500 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example, a method of generating sound with a computing device to increase a user's interaction performance with the computing device, the generated sound being in the form of voiced words speaking textual content to the user, the method comprising the steps of: identifying a first human entity referenced by the textual content; associating, with the first human entity, a first set of words of the textual content, the first set of words being those words that are indicated by the textual content as having been spoken by the first human entity; associating, with a narrator, a second set of words of the textual content, the second set of words being those words that are not indicated by the textual content as having been spoken, the narrator differing from the first human entity; determining one or more voice characteristics of the first human entity by referencing a knowledge source external to the textual content; selecting, from among existing computer voices having targeted voice characteristics, a first computer voice whose targeted voice characteristics correspond to the determined one or more voice characteristics; selecting, from among the existing computer voices having targeted voice characteristics, a narrator computer voice differing from the first computer voice; causing the computing device to generate a first portion of the sound by voicing the first set of words of the textual content using the first computer voice; and causing the computing device to generate a second portion of the sound by voicing the second set of words of the textual content using the narrator computer voice.

A second example is the method of the first example, further comprising the steps of: identifying additional human entities referenced by the textual content; associating, with the additional human entities, words of the textual content that are indicated by the textual content as having been spoken by individual ones of the additional human entities; determining one or more voice characteristics for each of the individual ones of the additional human entities; selecting, from among the existing computer voices having targeted voice characteristics, different computer voices for each of the individual ones of the additional human entities, the selected different computer voices having targeted voice characteristics corresponding to the determined one or more voice characteristics; and causing the computing device to generate other portions of the sound by voicing the words of the textual content that are indicated as having been spoken by the individual ones of the additional human entities using the selected different computer voices.

A third example is the method of the first example, wherein the causing comprises: generating a multiple voice readable textual content identifying that the first set of words are to be voiced using the first computer voice and that the second set of words are to be voiced using the narrator computer voice; and transmitting to the computing device the generated multiple voice readable textual content; wherein the computing device differs from a first computing device that performed the identifying, the associating, the determining and the selecting.

A fourth example is the method of the first example, wherein the determining the one or more voice characteristics of the first human entity comprises determining at least two of an age of the first human entity, a gender of the first human entity, and a nationality of the first human entity.

A fifth example is the method of the first example, further comprising independently deriving, from the textual content, voice characteristics of the first human entity.

A sixth example is the method of the first example, wherein the selecting the first computer voice comprises matching at least a first targeted voice characteristic of the first computer voice to a first voice characteristic of the first human entity determined by referencing the knowledge source, the matched voice characteristic having higher weight than any other voice characteristics.

A seventh example is the method of the first example, further comprising: identifying the first human entity based on a first long form name utilized within the textual content to nominate the first human entity; identifying the first human entity based on a first short form name also utilized within the textual content to nominate the first human entity; and associating the first long form name with the first short form name.

An eighth example is the method of the first example, further comprising utilizing co-reference resolution to associate specific pronouns within the textual content with the first human entity for purposes of performing the associating the first set of words with the first human entity.

A ninth example is the method of the first example, wherein the first human entity is a non-fictional entity.

A tenth example is the method of the first example, wherein the knowledge source external to the textual content is an encyclopedic source.

An eleventh example is a system generating sound in the form of voiced words speaking textual content to a user to increase the user's interaction performance, the system comprising: one or more server computing devices comprising: one or more processing units; one or more network interfaces; and one or more computer-readable storage media comprising computer-executable instructions which, when executed by the one or more processing units, cause the one or more server computing devices to perform steps comprising: identifying a first human entity referenced by a textual content provided to the one or more server computing devices; associating, with the first human entity, a first set of words of the textual content, the first set of words being those words that are indicated by the textual content as having been spoken by the first human entity; associating, with a narrator, a second set of words of the textual content, the second set of words being those words that are not indicated by the textual content as having been spoken, the narrator differing from the first human entity; determining one or more voice characteristics of the first human entity by referencing a knowledge source external to the textual content; selecting, from among existing computer voices having targeted voice characteristics, a first computer voice whose targeted voice characteristics correspond to the determined one or more voice characteristics; selecting, from among the existing computer voices having targeted voice characteristics, a narrator computer voice differing from the first computer voice; and generating a multiple voice readable textual content identifying that the first set of words are to be voiced using the first computer voice and that the second set of words are to be voiced using the narrator computer voice.

A twelfth example is the system of the eleventh example, further comprising: a client computing device comprising: one or more processing units; a network interface; at least one speaker; and one or more computer-readable storage media comprising computer-executable instructions which, when executed by the one or more processing units, cause the client computing device to perform steps comprising: receiving, through the network interface, the multiple voice readable textual content from the one or more server computing devices; generating, with the at least one speaker, a first portion of the sound by voicing the first set of words of the textual content using the first computer voice; and generating, with the at least one speaker, a second portion of the sound by voicing the second set of words of the textual content using the narrator computer voice.

A thirteenth example is the system of the eleventh example, wherein the one or more computer-readable storage media of the one or more server computing devices comprise further computer-executable instructions which, when executed by the one or more processing units, cause the one or more server computing devices to perform steps comprising: identifying additional human entities referenced by the textual content; associating, with the additional human entities, words of the textual content that are indicated by the textual content as having been spoken by individual ones of the additional human entities; determining one or more voice characteristics for each of the individual ones of the additional human entities; and selecting, from among the existing computer voices having targeted voice characteristics, different computer voices for each of the individual ones of the additional human entities, the selected different computer voices having targeted voice characteristics corresponding to the determined one or more voice characteristics.

A fourteenth example is the system of the eleventh example, wherein the determining the one or more voice characteristics of the first human entity comprises determining at least two of an age of the first human entity, a gender of the first human entity, and a nationality of the first human entity.

A fifteenth example is the system of the eleventh example, wherein the one or more computer-readable storage media of the one or more server computing devices comprise further computer-executable instructions which, when executed by the one or more processing units, cause the one or more server computing devices to perform steps comprising: independently deriving, from the textual content, voice characteristics of the first human entity.

A sixteenth example is the system of the eleventh example, wherein the selecting the first computer voice comprises matching at least a first targeted voice characteristic of the first computer voice to a first voice characteristic of the first human entity determined by referencing the knowledge source, the matched voice characteristic having higher weight than any other voice characteristics.

A seventeenth example is the system of the eleventh example, wherein the knowledge source external to the textual content is an encyclopedic website.

An eighteenth example is a computing device generating sound in the form of voiced words speaking textual content to a user to increase the user's interaction performance with the computing device, the computing device comprising: one or more processing units; at least one speaker; and one or more computer-readable storage media comprising computer-executable instructions which, when executed by the one or more processing units, cause the computing device to perform steps comprising: identifying a first human entity referenced by the textual content; associating, with the first human entity, a first set of words of the textual content, the first set of words being those words that are indicated by the textual content as having been spoken by the first human entity; associating, with a narrator, a second set of words of the textual content, the second set of words being those words that are not indicated by the textual content as having been spoken, the narrator differing from the first human entity; determining one or more voice characteristics of the first human entity by referencing a knowledge source external to the textual content; selecting, from among existing computer voices having targeted voice characteristics, a first computer voice whose targeted voice characteristics correspond to the determined one or more voice characteristics; selecting, from among the existing computer voices having targeted voice characteristics, a narrator computer voice differing from the first computer voice; generating, with the at least one speaker, a first portion of the sound by voicing the first set of words of the textual content using the first computer voice; and generating, with the at least one speaker, a second portion of the sound by voicing the second set of words of the textual content using the narrator computer voice.

A nineteenth example is the computing device of the eighteenth example, wherein the one or more computer-readable comprising further computer-executable instructions which, when executed by the one or more processing units, cause the computing device to perform steps comprising: identifying additional human entities referenced by the textual content; associating, with the additional human entities, words of the textual content that are indicated by the textual content as having been spoken by individual ones of the additional human entities; determining one or more voice characteristics for each of the individual ones of the additional human entities; selecting, from among the existing computer voices having targeted voice characteristics, different computer voices for each of the individual ones of the additional human entities, the selected different computer voices having targeted voice characteristics corresponding to the determined one or more voice characteristics; and generating, with the at least one speaker, other portions of the sound by voicing the words of the textual content that are indicated as having been spoken by the individual ones of the additional human entities using the selected different computer voices.

A twentieth example is the computing device of the eighteenth example, wherein the one or more computer-readable comprising further computer-executable instructions which, when executed by the one or more processing units, cause the computing device to perform steps comprising independently deriving, from the textual content, voice characteristics of the first human entity.

As can be seen from the above descriptions, mechanisms for increasing user interaction performance through the reading aloud of textual content by a computing device utilizing multiple computer voices have been presented. In view of the many possible variations of the subject matter described herein, we claim as our invention all such embodiments as may come within the scope of the following claims and equivalents thereto.

We claim:

1. A method of generating sound with a computing device to increase a user's interaction performance with the computing device, the generated sound being in the form of voiced words speaking textual content to the user, the method comprising the steps of:
identifying a first human entity referenced by the textual content;
associating, with the first human entity, a first set of words of the textual content, the first set of words being those words that are indicated by the textual content as having been spoken by the first human entity;
associating, with a narrator, a second set of words of the textual content, the second set of words being those words that are not indicated by the textual content as having been spoken, the narrator differing from the first human entity;
determining one or more voice characteristics of the first human entity by referencing a knowledge source external to the textual content;
selecting, from among existing computer voices having targeted voice characteristics, a first computer voice whose targeted voice characteristics correspond to the determined one or more voice characteristics;
selecting, from among the existing computer voices having targeted voice characteristics, a narrator computer voice differing from the first computer voice;
causing the computing device to generate a first portion of the sound by voicing the first set of words of the textual content using the first computer voice; and
causing the computing device to generate a second portion of the sound by voicing the second set of words of the textual content using the narrator computer voice.

2. The method of claim 1, further comprising the steps of:
identifying additional human entities referenced by the textual content;
associating, with the additional human entities, words of the textual content that are indicated by the textual content as having been spoken by individual ones of the additional human entities;
determining one or more voice characteristics for each of the individual ones of the additional human entities;
selecting, from among the existing computer voices having targeted voice characteristics, different computer voices for each of the individual ones of the additional human entities, the selected different computer voices having targeted voice characteristics corresponding to the determined one or more voice characteristics; and
causing the computing device to generate other portions of the sound by voicing the words of the textual content that are indicated as having been spoken by the individual ones of the additional human entities using the selected different computer voices.

3. The method of claim 1, wherein the causing comprises:
generating a multiple voice readable textual content identifying that the first set of words are to be voiced using the first computer voice and that the second set of words are to be voiced using the narrator computer voice; and
transmitting to the computing device the generated multiple voice readable textual content;
wherein the computing device differs from a first computing device that performed the identifying, the associating, the determining and the selecting.

4. The method of claim 1, wherein the determining the one or more voice characteristics of the first human entity comprises determining at least two of an age of the first human entity, a gender of the first human entity, and a nationality of the first human entity.

5. The method of claim 1, further comprising independently deriving, from the textual content, voice characteristics of the first human entity.

6. The method of claim 1, wherein the selecting the first computer voice comprises matching at least a first targeted voice characteristic of the first computer voice to a first voice characteristic of the first human entity determined by referencing the knowledge source, the matched voice characteristic having higher weight than any other voice characteristics.

7. The method of claim 1, further comprising:
identifying the first human entity based on a first long form name utilized within the textual content to nominate the first human entity;
identifying the first human entity based on a first short form name also utilized within the textual content to nominate the first human entity; and
associating the first long form name with the first short form name.

8. The method of claim 1, further comprising utilizing co-reference resolution to associate specific pronouns within the textual content with the first human entity for purposes of performing the associating the first set of words with the first human entity.

9. The method of claim 1, wherein the first human entity is a non-fictional entity.

10. The method of claim 1, wherein the knowledge source external to the textual content is an encyclopedic website.

11. A system generating sound in the form of voiced words speaking textual content to a user to increase the user's interaction performance, the system comprising:
one or more server computing devices comprising:
one or more processing units;
one or more network interfaces; and
one or more computer-readable storage media comprising computer-executable instructions which, when executed by the one or more processing units, cause the one or more server computing devices to perform steps comprising:
identifying a first human entity referenced by a textual content provided to the one or more server computing devices;
associating, with the first human entity, a first set of words of the textual content, the first set of words being those words that are indicated by the textual content as having been spoken by the first human entity;
associating, with a narrator, a second set of words of the textual content, the second set of words being those words that are not indicated by the textual content as having been spoken, the narrator differing from the first human entity;
determining one or more voice characteristics of the first human entity by referencing a knowledge source external to the textual content;
selecting, from among existing computer voices having targeted voice characteristics, a first computer voice whose targeted voice characteristics correspond to the determined one or more voice characteristics;
selecting, from among the existing computer voices having targeted voice characteristics, a narrator computer voice differing from the first computer voice; and
generating a multiple voice readable textual content identifying that the first set of words are to be voiced using the first computer voice and that the second set of words are to be voiced using the narrator computer voice.

12. The system of claim 11, further comprising:
a client computing device comprising:
one or more processing units;
a network interface;
at least one speaker; and
one or more computer-readable storage media comprising computer-executable instructions which, when executed by the one or more processing units, cause the client computing device to perform steps comprising:
receiving, through the network interface, the multiple voice readable textual content from the one or more server computing devices;
generating, with the at least one speaker, a first portion of the sound by voicing the first set of words of the textual content using the first computer voice; and
generating, with the at least one speaker, a second portion of the sound by voicing the second set of words of the textual content using the narrator computer voice.

13. The system of claim 11, wherein the one or more computer-readable storage media of the one or more server computing devices comprise further computer-executable instructions which, when executed by the one or more processing units, cause the one or more server computing devices to perform steps comprising:
identifying additional human entities referenced by the textual content;
associating, with the additional human entities, words of the textual content that are indicated by the textual content as having been spoken by individual ones of the additional human entities;
determining one or more voice characteristics for each of the individual ones of the additional human entities; and
selecting, from among the existing computer voices having targeted voice characteristics, different computer voices for each of the individual ones of the additional human entities, the selected different computer voices having targeted voice characteristics corresponding to the determined one or more voice characteristics.

14. The system of claim 11, wherein the determining the one or more voice characteristics of the first human entity comprises determining at least two of an age of the first human entity, a gender of the first human entity, and a nationality of the first human entity.

15. The system of claim 11, wherein the one or more computer-readable storage media of the one or more server computing devices comprise further computer-executable instructions which, when executed by the one or more processing units, cause the one or more server computing devices to perform steps comprising:
independently deriving, from the textual content, voice characteristics of the first human entity.

16. The system of claim 11, wherein the selecting the first computer voice comprises matching at least a first targeted voice characteristic of the first computer voice to a first voice characteristic of the first human entity determined by referencing the knowledge source, the matched voice characteristic having higher weight than any other voice characteristics.

17. The system of claim 11, wherein the knowledge source external to the textual content is an encyclopedic source.

18. A computing device generating sound in the form of voiced words speaking textual content to a user to increase the user's interaction performance with the computing device, the computing device comprising:
one or more processing units;
at least one speaker; and
one or more computer-readable storage media comprising computer-executable instructions which, when executed by the one or more processing units, cause the computing device to perform steps comprising:
identifying a first human entity referenced by the textual content;
associating, with the first human entity, a first set of words of the textual content, the first set of words being those words that are indicated by the textual content as having been spoken by the first human entity;
associating, with a narrator, a second set of words of the textual content, the second set of words being those words that are not indicated by the textual content as having been spoken, the narrator differing from the first human entity;
determining one or more voice characteristics of the first human entity by referencing a knowledge source external to the textual content;
selecting, from among existing computer voices having targeted voice characteristics, a first computer voice whose targeted voice characteristics correspond to the determined one or more voice characteristics;
selecting, from among the existing computer voices having targeted voice characteristics, a narrator computer voice differing from the first computer voice;
generating, with the at least one speaker, a first portion of the sound by voicing the first set of words of the textual content using the first computer voice; and
generating, with the at least one speaker, a second portion of the sound by voicing the second set of words of the textual content using the narrator computer voice.

19. The computing device of claim 18, wherein the one or more computer-readable comprising further computer-executable instructions which, when executed by the one or more processing units, cause the computing device to perform steps comprising:
identifying additional human entities referenced by the textual content;
associating, with the additional human entities, words of the textual content that are indicated by the textual content as having been spoken by individual ones of the additional human entities;
determining one or more voice characteristics for each of the individual ones of the additional human entities;
selecting, from among the existing computer voices having targeted voice characteristics, different computer voices for each of the individual ones of the additional human entities, the selected different computer voices having targeted voice characteristics corresponding to the determined one or more voice characteristics; and
generating, with the at least one speaker, other portions of the sound by voicing the words of the textual content that are indicated as having been spoken by the individual ones of the additional human entities using the selected different computer voices.

20. The computing device of claim 18, wherein the one or more computer-readable comprising further computer-executable instructions which, when executed by the one or more processing units, cause the computing device to perform steps comprising independently deriving, from the textual content, voice characteristics of the first human entity.
